(19) United States
(12) Patent Application Publication
(10) Pub. No.: US 2026/0072210 A1
(43) Pub. Date: Mar. 12, 2026

(54) STRUCTURE FOR EXTRACTING A GUIDED MODE

(71) Applicant: COMMISSARIAT A L'ENERGIE ATOMIQUE ET AUX ENERGIES ALTERNATIVES, Paris (FR)

(72) Inventors: Christophe MARTINEZ, Grenoble Cedex 09 (FR); Salaheddine TOUBI, Grenoble Cedex 09 (FR)

(73) Assignee: COMMISSARIAT A L'ENERGIE ATOMIQUE ET AUX ENERGIES ALTERNATIVES, Paris (FR)

(21) Appl. No.: 19/323,072

(22) Filed: Sep. 9, 2025

(30) Foreign Application Priority Data
Sep. 10, 2024 (FR) FR2409630

(51) Int. Cl. G02B 6/12; G02B 6/132

(52) U.S. Cl. CPC G02B 6/12004; G02B 6/132; G02B 2006/121; G02B 2006/12104; G02B 2006/12116; G02B 2006/12147

(57) ABSTRACT

A structure for extracting a guided mode of wavelength λ, linearly polarized, including: a main waveguide capable of guiding the guided mode; a liquid crystal intermediate waveguide capable of guiding a coupled mode, extending parallel to the upper face of a substrate; a flat reflective surface facing an output face of the intermediate waveguide, making a non-zero angle with the substrate; first and second electrodes arranged in relation to the core of the intermediate waveguide so as to switch a refractive index of the liquid crystal from a first level to a second level, when a variation of an electrical potential difference is applied between the first and second electrodes. The guided mode is coupled by coupled mode evanescent coupling only when the refractive index of the liquid crystal is equal to the second level.

### TECHNICAL FIELD

The field of the invention is that of structures for extracting a guided mode propagating in an integrated waveguide. More specifically, the invention relates to an active extraction structure making it possible to control the extraction of the guided mode. It also relates to a method for manufacturing such an extraction structure and an optical device implementing a plurality of active extraction structures.

### PRIOR ART

Structures for extracting a guided mode are known from the field of integrated photonics. For example, surface diffraction gratings exist. A surface diffraction grating is a periodic structure etched on the surface of a waveguide wherein the guided mode propagates. The period of the surface grating is adapted to selectively diffract the wavelength of the guided mode, making it possible to extract at least a part thereof. For example, surface diffraction gratings are used for extracting a guided mode from a waveguide to an optical fiber or vice versa. They are often preferred to edge couplers and are sometimes indispensable, particularly for testing photonic chips before individualization by cutting. Diffraction gratings are generally passive extraction structures, that is to say that the extraction efficiency thereof is fixed once and for all during the manufacture thereof.

Active structures also exist for extracting a guided mode propagating in an integrated waveguide, that is to say controllable between an open state for which at least part of the energy of the guided mode is extracted from the waveguide to generate a directional light beam, and a closed state for which the guided mode remains entirely confined in the waveguide. Most of the energy of the directional light beam propagates within a solid angle strictly less than 2π steradians around a main direction. For example, the solid angle may be less than 0.5π steradians. When it is in an open state, the extraction structure is said to be activated.

Active extraction structures are used, for example, in displays for extended reality applications (augmented reality, virtual reality or mixed reality). To name an example, they have recently been used in a new type of augmented reality micro-display exploiting an autofocus effect, such as that described in the document by C. Martinez et al. “See-through holographic retinal projection display concept”, Optica, vol. 5, no. 10, p. 120 Oct. 2018, doi: 10.1364/OPTICS.5.001200. This type of micro-display makes it possible to dispense with optical systems to project an image into the eye of a user, and consequently can be integrated into less complex, less bulky, and less heavy optical systems.

In general terms, a pixel of such a display results from the combination of a plurality of light waves that are coherent with each other, resulting from a distribution of emission points. The light is directed to the emission points by a grating of integrated waveguides, which are optically connected to a light source. Each emitting point includes an active extraction structure for extracting light on command from a corresponding waveguide. A holographic film disposed on the active extraction structures makes it possible to adjust the phase and the direction of the light extracted by the active extraction structures. For example, the emission points may emit light waves having the same modulo phase 2π and propagating around parallel main axes. In this case, the eye of the observer sees a sharp point corresponding to a virtual pixel located at infinity. A control circuit connected to the light source and to an array of electrodes makes it possible to simultaneously activate the light source and the extraction structures corresponding to the pixel.

The document by Matthias Colard et al., “Study of a liquid crystal impregnated diffraction grating for active waveguide addressing,” Proc. SPIE 12023, Emerging Liquid Crystal Technologies XVII, 1202302 (3 Mar. 2022); doi: 10.1117/12.2607475 describes two embodiments of an active extraction structure suitable for producing micro-displays exploiting an autofocus effect.

A first embodiment aims to modify the index contrast of a diffraction grating. It implements a surface diffraction grating formed on a waveguide; the surface grating bathing in a liquid crystal. For example, the refractive index of the surface grating is substantially equal to the ordinary refractive index of the liquid crystal. A pair of electrodes makes it possible to apply an electric field in the liquid crystal, perpendicular to the mean plane of the surface grating. When an electrical potential difference is applied between the two electrodes, the electric field aligns the molecules of the liquid crystal perpendicularly to the mean plane of the surface grating. A transverse electric (TE) mode guided by the waveguide meets a uniform structure having a refractive index equal to the ordinary index. It therefore remains largely confined inside the waveguide. Conversely, when the electrodes are at the same electrical potential, the electric field is zero in the liquid crystal and the molecules of the liquid crystal orient in a direction parallel to the mean plane of the surface grating. The transverse electric TE mode then interacts with a medium having a refractive index substantially equal to the ordinary index at a tooth of the surface grating, and a refractive index medium equal to the extraordinary refractive index of the liquid crystal between two teeth of the surface grating. Consequently, it is diffracted and partially extracted from the waveguide. In the case where the transverse electric (TE) mode does not perceive refractive index modulation at the diffraction grating, however, a small part of this mode is diffracted by an anchoring layer of the liquid crystal that contours the diffraction grating.

A second embodiment makes it possible to resolve this drawback. It aims to modify the confinement of a guided mode to make it interact or not with a diffraction grating. In this embodiment, a liquid crystal extends from a lower face to an upper face. A core of a waveguide is in contact with the lower face. A diffraction grating is formed in the liquid crystal and is flush with the upper face of the liquid crystal. The diffraction grating includes teeth disposed perpendicular to an optical axis of the waveguide. Interdigitated electrodes made of indium tin oxide (ITO) are arranged in a plane parallel to the upper face, facing the liquid crystal on one side opposite the lower face. The electrodes are capable of applying an electric field in the liquid crystal parallel to the optical axis of the waveguide. An anchoring layer makes it possible to align the molecules of the liquid crystal parallel to the teeth of the diffraction grating in the absence of an electric field in the liquid crystal. The core of the waveguide has a refractive index greater than or equal to an extraordinary refractive index (ne) of the liquid crystal.

Thus, in operation, when an electrical potential difference is applied to the terminals of the electrodes, the molecules of the liquid crystal align parallel to the optical axis. A transverse electric (TE) polarized mode then interacts with a coating having a refractive index equal to the ordinary refractive index (no) of the liquid crystal. The refractive index contrast between the core and the coating is therefore maximum and the TE-type mode remains sufficiently confined to not interact with the diffraction grating. No light is then extracted. Conversely, when the electrodes are at the same electrical potential, the electric field is substantially zero in the liquid crystal. The molecules of the liquid crystal are aligned parallel to the teeth of the diffraction grating. The TE-type mode then interacts with a refractive index coating equal to the extraordinary refractive index (ne) of the liquid crystal. The refractive index contrast between the core and the coating is therefore minimal and an evanescent part of the TE-type mode extends to the diffraction grating. Part of the TE-type mode is then extracted from the waveguide.

However, these two embodiments have the drawback of diffracting the guided mode in unnecessary or parasitic diffraction orders, which consequently induces undesirable losses, and a lack of directivity of the light extracted by the active extraction structure. For the specific application of micro-displays, the orders of parasitic diffractions may form parasitic images. In addition, the maximum power of the extracted light is achieved for a long diffraction grating length. As a result, the active extraction structure is bulky.

### DISCLOSURE OF THE INVENTION

The object of the invention is to remedy at least partially the drawbacks of the prior art, and more particularly to propose a structure for extracting a guided mode having low losses and making it possible to increase the directivity of a light extracted by the extraction structure. Another object of the invention is to propose an optical device, such as a micro-display, which is brighter and more compact.

For this purpose, the object of the invention is a structure for extracting a guided mode of wavelength λ, linearly polarized along a polarization direction, including: a support substrate comprising a substantially flat upper face; a main waveguide capable of guiding the guided mode; an intermediate waveguide capable of guiding a so-called coupled mode, at the wavelength λ, comprising a liquid crystal core extending parallel to the upper face, and an output face, the core extending to the output face; a flat surface facing the output face, reflective at the wavelength λ, making a non-zero angle with the upper face of the support substrate; a first electrode and a second electrode, arranged in relation to the core of the intermediate waveguide so as to switch, in a coupling portion of the core of the intermediate waveguide, a refractive index of the liquid crystal, according to the polarization direction, from a first level to a second level, when a variation of an electrical potential difference is applied between the first and the second electrodes.

The first level, the second level, and the arrangement of the coupling portion in relation to the main waveguide are such that the guided mode, when it is present, is at least partially coupled, by evanescent coupling of the main waveguide to the coupling portion only when the refractive index of the coupling portion is equal to the second level.

Certain preferred but non-limiting aspects of this sensor are as follows.

The first electrode may be referred to as buried. The buried electrode, the main waveguide, the intermediate waveguide and the second electrode may extend in distinct planes, parallel to the upper face of the support substrate, the main waveguide and the intermediate waveguide being interposable between the buried electrode and the second electrode.

The flat reflective surface may be an interface between a first medium and a second medium transparent at the wavelength λ, the first medium being arrangeable between the output face and the flat reflective surface and being able to have a refractive index strictly greater than a refractive index of the second medium, and such that, when the guided mode is present and at least partially coupled, a transmitted light wave from the guided mode may propagate from the output face to the flat reflective surface along a main axis that may make an angle α with a normal to the flat reflective surface greater than or equal to a minimum angle of incidence on the flat reflective surface for which the light is totally reflected.

The intermediate waveguide may have an end opposite the main waveguide, the core being able to extend from the end to the output face.

The end may make a non-zero angle with the upper face of the support substrate so as to achieve an adiabatic coupling region.

The flat reflective surface may be a metallized surface.

The guided mode may be a TM mode, the liquid crystal may include a nematic phase, and the second level may be an extraordinary refractive index of the liquid crystal.

The wavelength λ may be within the visible spectrum.

The invention also relates to an optical device including a first group of a plurality of extraction structures according to any one of the preceding features, sharing the support substrate, such that the main waveguide of each extraction structure is a portion of a first main waveguide.

The optical device may further include a second group of a plurality of extraction structures according to any one of the preceding features, which may share the support substrate with each other and with the extraction structures of the first group. The main waveguide of each extraction structure of the second group may be a portion of a second main waveguide distinct from the first main waveguide.

Each extraction structure of the first group may correspond to a corresponding extraction structure of the second group such that the intermediate waveguides thereof may be two portions of a common intermediate waveguide.

The flat reflective surface of each extraction structure of the first group and, if applicable, of the second group may be the end of the intermediate waveguide of another extraction structure of the same group.

All intermediate waveguides of the extraction structures may have equal heights, measured perpendicular to the upper face.

The invention also relates to a method for manufacturing an extraction structure or an optical device according to any one of the preceding features: including the following steps: providing a support substrate including a main waveguide; providing an encapsulation substrate; forming a structured layer on the support substrate or the encapsulation substrate, by a nanoimprint lithography method, the structured layer including protruding parts of identical heights equal to a common height; forming an adhesive bead on the support substrate or the encapsulation substrate, such that the adhesive bead has a thickness greater than or equal to the common height, delimits a central region, and includes a through lateral opening communicating with the central region; transferring the encapsulation substrate onto the support substrate so that the structured layer acts as a spacer fixing a gap between the encapsulation substrate and the support substrate, and delimits a continuous volume in the central region intended to be the core of the intermediate waveguide; bonding the encapsulation substrate to the support substrate by the adhesive bead; introducing a liquid crystal into the continuous volume through the through lateral opening.

The nanoimprint lithography method may implement a reference mold obtained by the following steps: providing a temporary substrate that may include an upper face and trenches that may extend deep into the temporary substrate from the upper face; filling the trenches with a positive photosensitive resin; insolating the positive photosensitive resin by a collimated light that may propagate in the positive photosensitive resin in a direction making an angle θ₀ between 30° and 60° with the upper face.

### BRIEF DESCRIPTION OF THE DRAWINGS

Other aspects, aims, advantages and features of the invention will become better apparent upon reading the following detailed description of preferred embodiments thereof, provided as a non-limiting example, and made with reference to the appended drawings wherein:

FIG. 1A is a schematic sectional view of a first embodiment of an extraction structure according to the invention;

FIG. 1B is a schematic sectional view of a detail of the first embodiment;

FIG. 2 is a schematic sectional view of a second embodiment of an extraction structure according to the invention;

FIG. 3 is a schematic sectional view of a third embodiment of an extraction structure according to the invention;

FIG. 4A is a schematic sectional view of an example of optical device implementing extraction structures according to the first embodiment;

FIG. 4B is a perspective view of a detail of the example of optical device;

FIGS. 5A to 5D are simulation results leading to the optimization of an extraction structure according to the invention;

FIG. 6 is a simulation result of the first embodiment;

FIGS. 7A to 7H are schematic sectional views of steps of a method for manufacturing a reference mold and a stamp mold that may be used to produce an extraction structure according to the invention;

FIGS. 8A to 8D are schematic sectional views of steps of a method for manufacturing an upper part of an extraction structure according to the invention;

FIGS. 9A and 9B are schematic cross-sectional views of steps of a method for manufacturing an extraction structure according to the invention integrating the upper part.

### DETAILED DISCLOSURE OF SPECIFIC EMBODIMENTS

In the figures and in the following description, the same references represent identical or similar elements. In addition, the different elements are not shown to scale so as to favor clarity of the figures. Moreover, the various embodiments and alternative embodiments are not mutually exclusive and may be combined. Unless stated otherwise, the terms “substantially”, “about”, “in the order of” mean within a 10% margin, and preferably within a 5% margin. Moreover, the terms “between . . . and . . . ” and equivalents mean that the bounds are included, unless stated otherwise.

The invention relates to a structure for extracting a guided mode of wavelength λ. It includes a support substrate, a main waveguide and an intermediate waveguide. The intermediate waveguide includes a core that comprises a liquid crystal. The liquid crystal has an ordinary refractive index (no) and an extraordinary refractive index (ne). The main waveguide may be separated from the intermediate waveguide by an upper encapsulation layer. The upper encapsulation layer has a refractive index strictly lower than the extraordinary refractive index (ne) and a refractive index of the core of the main waveguide.

The extraction structure further includes a first electrode and a second electrode arranged, in relation to the intermediate waveguide, so as to apply an electric field in a coupling portion of the liquid crystal. In an illustrative embodiment of the invention, the electric field is capable of orienting molecules of the liquid crystal in a direction orthogonal to a direction adopted by the molecules in the absence of an electric field in the liquid crystal. Thus, by modifying the amplitude of the electric field, the extraction structure switches between an open state for which a part of at least one mode guided by the main waveguide is coupled by evanescent coupling of the main waveguide to the intermediate waveguide, and a closed state for which the guided mode remains entirely confined in the main waveguide. That is to say that a variation of an electrical potential difference applied between the first electrode and the second electrode causes the refractive index of the intermediate waveguide to vary so as to make it possible to propagate a mode of the intermediate waveguide which has a propagation constant equal to the propagation constant of the mode guided by the main waveguide—in this case, the effective indices of the two modes are equal.

A redirecting reflective surface facing an output face of the intermediate waveguide subsequently deflects the part of the guided mode toward the medium surrounding the extraction structure. Activating an evanescent coupling in combination with the reflective surface makes it possible for the light to be extracted efficiently, with minimal losses, in a single angular direction.

Throughout the description, the term “effective index of a mode guided by a waveguide” is given the common meaning thereof in the technical field of the invention. The effective index is a weighted average of the refractive indices of the materials constituting the waveguide. It is connected to the propagation constant β of the mode guided by the waveguide by the relationship

$$β = \frac{2 π {n}_{eff}}{λ} ,$$

where n_{eff} IS the effective index and λ the wavelength of the guided mode. The propagation constant β and/or the effective index n_{eff} may for example be determined by simulation.

Throughout the description, a waveguide is a single-mode or multi-mode waveguide capable of confining light, as opposed to optical guides within which light propagates by total internal reflection. Without further clarification, a waveguide can be of any type. It can be, for example, a strip, ridge or planar guide. A waveguide has a core, sometimes called a guiding path, and a coating surrounding the core so as to be in physical contact therewith. A contrast or a variation of refractive indices between the core and the coating makes it possible to confine the light. The coating may comprise a plurality of distinct parts and be made of one or more different materials. The waveguides are referenced by the cores thereof in the figures. Similarly, without further precision, a refractive index of a waveguide is a refractive index of the core of the waveguide; a distance separating two waveguides is the distance separating the cores of the respective waveguides; the material of a waveguide is the material of the core of the waveguide; when a waveguide extends in a direction, it is understood that the core of the waveguide extends in this direction; when a waveguide is in contact with a layer, it is understood that the core of the waveguide is in contact with the layer.

Layer means an area consisting of one or more sub-layers of a material of which the thickness along a Z-axis is less than, for example ten times, or even twenty times, the longitudinal width and length dimensions thereof in a plane (X, Y) perpendicular to the Z-axis. A layer may be conformal, in this case it contours the topology of the surface on which it rests. When it consists of a plurality of sub-layers, the sub-layers may be made from different materials. The sub-layer(s) extend(s) in planes substantially parallel to the plane (X, Y).

Particular embodiments will be described relating to a structure for extracting a guided mode of wavelength λ including a main waveguide and an intermediate waveguide comprising a material having a refractive index that may vary between a high value and a low value under the effect of a controllable physical stimulus. In these particular examples, the physical stimulus is an electric field and the material is a liquid crystal. However, these embodiments may be adapted to other optoelectronic devices, for example an optical switch capable of sending two optical signals guided by the main waveguide to two distinct output channels and simultaneously switching each optical signal from one output channel to the other. In this example, the optical signals may be of different wavelengths and/or of different polarization.

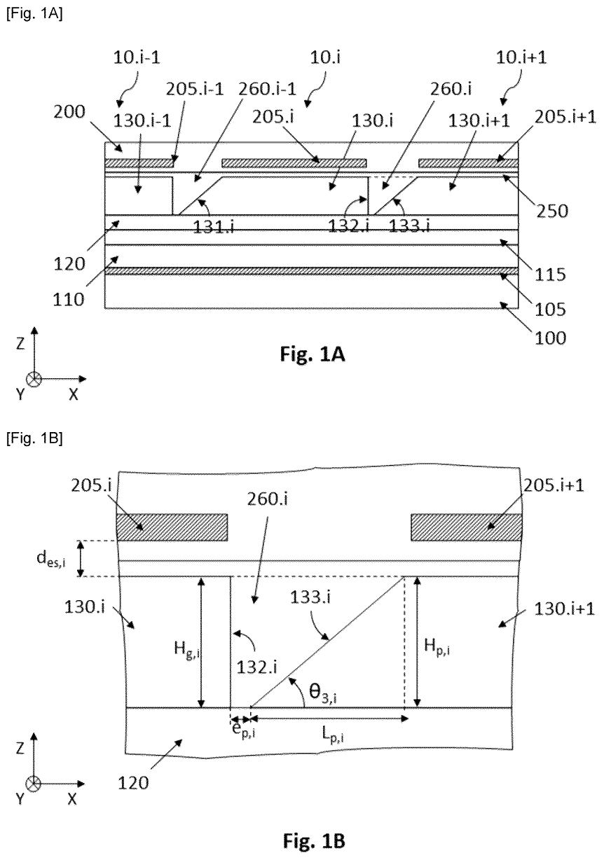

A first embodiment of an extraction structure 10.i according to the invention will be described in connection with FIGS. 1A and 1B. The extraction structure 10.i includes a support substrate 100, a main waveguide 115, an intermediate waveguide 130.i, a reflective surface 133.i, a first electrode 105 and a second electrode 205.i.

For the sake of clarity, this first embodiment, as well as the following, are described for a specific operation, for which the guided mode is transverse magnetic (TM) polarized, and the extraction structure is activated when a non-zero potential difference is applied between the first electrode 105 and the second electrode 205.i, without the invention being limited to this type of operation. The extraction structure 10.i according to the invention may also be capable of extracting an electrical transverse (TE) polarized guided mode when a zero or non-zero potential difference is applied between the first electrode 105 and the second electrode 205.i. The extraction structure 10.i according to the invention may also be capable of extracting a transverse magnetic (TM) polarized mode when the first and second electrodes are at the same potential. For some of these alternative embodiments within the reach of a person skilled in the art, it is necessary to modify the arrangement of the first and second electrodes (105, 205.i) in relation to the intermediate waveguide 130.i and/or the orientation of an extraordinary axis of the liquid crystal in the absence of an electric field in the liquid crystal.

The support substrate 100 may for example be derived from a plate, possibly after a cutting and/or thinning step. The plate may for example be a glass, silicon or quartz plate. The support substrate 100 may have a thickness sufficiently thin to be able to be curved by application of a force. It has an upper face and a lower face opposite the upper face. The lower and upper faces are substantially flat and substantially parallel to each other. The main waveguide 115 rests on the support substrate 100 on a side opposite the lower face and extends parallel to the upper face of the support substrate 100. In this example, the main waveguide 115 is straight. It can also be curved.

Herein and for the remainder of the description, an orthogonal three-dimensional direct reference point (X, Y, Z) is defined, where the X and Y axes form a plane parallel to the upper face of the support substrate 100, the X-axis here being parallel to the main waveguide 115, and where the Z-axis is oriented substantially orthogonally to the upper face of the support substrate 100, from the lower face to the upper face. In the following description, the terms “vertical” and “vertically” are defined as relating to a direction substantially parallel to the Z-axis, and the terms “horizontal” and “horizontally” as relating to an orientation substantially parallel to the plane (X, Y). Moreover, the terms “lower” and “upper” mean as relating to an increasing positioning when moving away from the support substrate 100 in the direction +Z.

In the orthogonal three-dimensional direct reference (X, Y, Z), a unit vector normal to a face, a surface, or a plane has for spherical coordinates: x=sin θ cos ø, y=sin θ sin φ and z=cos θ. In the description, the orientation of a face, of a surface or of a plane is defined by the spherical coordinates (θ, φ) of a unit vector normal to the face, to the surface or to the plane, such as θϵ[0°; 180°]. The face, the surface or the plane is said to have for angular orientation, the angles (θ, φ). For a planar diopter separating a first medium from a second medium with a refractive index strictly lower than a refractive index of the first medium, the reference unit vector, normal to the diopter, of spherical coordinates (θ, φ) is oriented from the second medium to the first medium.

The first electrode 105 here rests on the upper face of the support substrate 100, possibly separated therefrom by one or more layers, for example an electrically insolating layer. The first electrode 105 is made of an electrically conductive material, for example a metal or, a metal oxide, such as indium-tin oxide (ITO) or aluminum-doped zinc oxide (AZO).

The main waveguide 115 is advantageously a single-mode guide. For example, it has dimensions along the Y and Z axes in the order of the wavelength λ, or less than or equal to λ, for example between 0.5λ and 1.5λ. The main waveguide 115 is separated from the first electrode 105 by a lower encapsulation layer 110. The lower encapsulation layer 110 is in physical contact with the first electrode 105 and the main waveguide 115. In this configuration, the first electrode 105 is referred to as buried. Here, the main waveguide 115 is a strip waveguide, but it may be of another type, for example of ridge or rib type. It is for example made of silicon (Si) or, as in this example, silicon nitride (SiN). The lower encapsulation layer 110 is made of one or more dielectric materials transparent at the wavelength λ. The dielectric material(s) have refractive indices strictly lower than a refractive index of the main waveguide 115. Here, the lower encapsulation layer 110 is made of silicon oxide. It has a thickness of between 100 nm and 2 μm, for example equal to 1 μm.

The intermediate waveguide 130.i includes a core, separated from the main waveguide 115 by an upper encapsulation layer 120. The core extends parallel to the upper face of the support substrate 100 from an end 131.i to an output face 132.i. It comprises a liquid crystal. A proximal liquid crystal portion of the core is at least opposite the main waveguide 115, that is to say there is a straight line parallel to the Z-axis passing through the core of the main waveguide 115 and through the proximal portion, for any section of the proximal portion parallel to the plane (Y, Z). The main waveguide 115 is preferably fully opposite the proximal portion. Here, the end 131.i and the output face 132.i are interfaces between the liquid crystal and the media surrounding the intermediate waveguide 130.i. In this particular example, the proximal portion extends from the end 131.i to the output face 132.i, such that the end 131.i and the output face 132.i are facing the main waveguide 115.

For example, the liquid crystal has a nematic phase. It has an ordinary refractive index (no) and an extraordinary refractive index (ne). The ordinary refractive index (no) is the refractive index affecting a light wave propagating in the liquid crystal, linearly polarized along a direction perpendicular to the mean orientation of the electric dipoles of the molecules of the liquid crystal. The extraordinary refractive index (ne) is the refractive index affecting a light wave propagating in the liquid crystal, linearly polarized along a direction parallel to the mean orientation of the electric dipoles of the molecules of the liquid crystal. “Orientation of the molecules of a liquid crystal” means the average orientation of the electrical dipoles of the molecules of the liquid crystal having an electrical dipole. In the absence of an electric field in the liquid crystal, one or more anchoring layers, not shown in FIGS. 1A, 1B, 2, 3, 4A, 4B and 6, orient the molecules of the liquid crystal in a predominant direction, also called preferred direction.

The liquid crystal is for example a 5CB liquid crystal (4′-pentyl-4-biphenylcarbonitrile or 4-cyano-4′-pentylbiphenyl or 4-pentyl-4′-cyanobiphenyl). For example, the ordinary refractive index (no) is equal to 1.545 and the extraordinary refractive index (ne) equal to 1.735 for a wavelength λ equal to 532 nm.

The upper encapsulation layer 120 is in contact with the main waveguide 115 and the core of the intermediate waveguide 130.i. It is made of one or more dielectric materials transparent at the wavelength λ. The dielectric material(s) have refractive indices strictly lower than a refractive index of the main waveguide 115 and the extraordinary refractive index (ne) of the liquid crystal. Preferably, the refractive index(es) of the dielectric material(s) is greater than or equal to the ordinary refractive index (no) of the liquid crystal and less than or equal to 1.1 times the ordinary refractive index (no) of the liquid crystal. Here, the upper encapsulation layer 120 is made of silicon oxide. For example, it has a thickness between 10 nm and 100 nm, measured vertically above the main waveguide 115.

The second electrode 205.i is arranged in an encapsulation substrate 200 and extends parallel to the upper face of the support substrate 100. The main waveguide 115 and the intermediate waveguide 130.i are interposed between the buried electrode 105 and the second electrode 205.i. From the arrangement thereof in relation to the support substrate 100, in this particular example, the second electrode 205.i is referred to as the upper electrode 205.i. At least a part of the upper electrode 205.i is opposite the proximal portion of the core of the intermediate waveguide 130.i and opposite the buried electrode 105. It is located at a distance d_{es,i} preferably not zero from the intermediate waveguide 130.i. The distance d_{es,i} is for example between 100 nm and 2 μm, for example equal to 1 μm. The upper electrode 205.i is made of an electrically conductive material, for example metal or a metal oxide, such as indium-tin oxide (ITO) or aluminum-doped zinc oxide (AZO).

The encapsulation substrate 200 is, in this example, transparent at the wavelength λ. It is for example mainly made of silicon (Si), of germanium (Ge), or as in this example made of quartz or glass. It may possibly comprise layers transparent at the wavelength λ, such as for example one or more layers of silicon oxide or of silicon nitride (SiN). The encapsulation substrate 200 rests on the intermediate waveguide 130.i on a side opposite the buried electrode 105, for example in physical contact therewith or, as shown herein, separated therefrom by a portion of a material in physical contact with the intermediate waveguide 130.i and the encapsulation substrate 200. If the material has a refractive index greater than or equal to the extraordinary refractive index (ne) of the liquid crystal, the portion of the material preferably has a thickness less than 20 nm, or even less than 10 nm. The refractive index of the encapsulation substrate 200 is strictly lower than the extraordinary refractive index (ne) over an entire lower region of the encapsulation substrate 200 extending from the upper electrode 205.i to a lower face of the encapsulation substrate 200.

The reflective surface 133.i is a substantially flat surface. It is positioned facing the output face 132.i. It is in physical contact with the upper encapsulation layer 120. As shown in FIG. 1B, the reflective surface 133.i has an angular orientation (θ_{3,i}, φ_{3,i}) such that, in operation, a light beam derived from the guided mode transmitted through the output face 132.i and reflected by the reflective surface 133.i, propagates into the half-space opposite the support substrate 100 and delimited by an upper face of the encapsulation substrate 200, or in the half-space opposite the encapsulation substrate 200 and delimited by the lower face of the support substrate 100.

The end 131.i has for angular orientation the angles (θ_{1,i}, φ_{1,i}). Advantageously, θ_{1,i} is included in an angle range making an adiabatic coupling of a part of the guided mode possible from the main waveguide 115 to the intermediate waveguide 130.i, when the extraction structure 10.i is activated. In this example, this goal is achieved when θ_{1,i} is between 30° and 50°, for example equal to 35°. The core of the intermediate waveguide 130.i consequently includes a straight portion extending from the end 131.i to the output face 132.i of constant height, measured parallel to the Z-axis.

The output face 132.i has for angular orientation the angles (θ_{2,i}, φ_{2,i}). In this example, φ_{1,i}=φ_{2,i}=φ_{3,i}=0; θ_{2,i}=90°; θ_{3,i} is strictly between 0° and 90°. The output face 132.i is therefore consequently orthogonal to the plane (X, Y).

The reflective surface 133.i has a height H_{p,i} greater than or equal to a height H_{g,i} of the intermediate waveguide 130.i, the heights being measured parallel to the Z-axis. Advantageously, as in this example, H_{p,i} is equal to H_{g,i}. The reflective surface 133.i is located at a distance epi from the output face 132.i, measured parallel to the plane (X, Y). e_{p,i} is the smallest distance separating the reflective surface 133.i from the output face 132.i in a horizontal plane. The distance epi is for example less than 20 nm, preferably less than 10 nm, advantageously the smallest possible, it being understood that it may be zero. The reflective surface 133.i has a length L_{p,i} measured parallel to the X-axis, such that tan

$${θ}_{3 \cdot i} = \frac{{H}_{p , i}}{{L}_{p , i}} .$$

Advantageously, as is the case in this example, the reflective surface 133.i may be a planar diopter between a first transparent medium and a second medium transparent at the wavelength λ. The first medium is a high-index region 260.i extending parallel to the upper face of the support substrate 100 from the output face 132.i to the reflective surface 133.i. The high-index region 260.i has a refractive index strictly higher than a refractive index of the second medium. In this example, the high-index region 260.i is a part of a structured layer 250 resting on the upper encapsulation layer 120 and encapsulating the core of the intermediate waveguide 130.i. The structured layer 250 is in contact with the entire end 131.i, the entire output face 132.i and possibly with the upper encapsulation layer 120, as shown here. In this example, when the encapsulation substrate 200 is separated from the intermediate waveguide 130.i by the portion of material, the structured layer 250 comprises the portion of material. The refractive index of the high-index region 260.i is for example between 1.5 and 2, preferably between 1.8 and 2, for example equal to 1.9.

In this example, without this being essential, the reflective surface 133.i is a diopter between the high-index region 260.i and the core of the intermediate waveguide 130.i+1 of an additional extraction structure 10.i+1 according to the first embodiment. The reflective surface 133.i is coplanar with the end 131.i+1 of the intermediate waveguide 130.i+1 of the additional extraction structure 10.i+1. Similarly, the end 131.i is coplanar with the reflective surface 133.i−1 of another additional extraction structure 10.i−1 according to the first embodiment. Thus, the additional extraction structures 10.i−1, 10.i+1 respectively include additional upper electrodes 205.i−1, 205.i+1. The high-index region 260.i−1 of the additional extraction structure 10.i−1 extends from the output face 132.i−1 of the intermediate waveguide 130.i−1 of the additional extraction structure 10.i−1 to the end 131.i of the intermediate waveguide 130.i of the extraction structure 10.i.

Alternatively, the reflective surface 133.i may be a metallized surface comprising a metal, for example aluminum (Al) or silver (Ag). In this case, the refractive index of the high-index region 260.i may be any, and preferably substantially equal to ne.

In operation, a transverse magnetic (TM) polarized mode and of wavelength λ is guided along the +X-axis by the main waveguide 115 toward the end 131.i of the intermediate waveguide 130.i. A non-zero potential difference is applied between the buried electrode 105 and the upper electrode 205.i so as to create an electric field sufficient to orient molecules of the liquid crystal parallel to the electric field. With the upper electrode 205.i and the buried electrode 105 being opposite and facing the proximal portion, the electric field is substantially parallel to the Z-axis in a substantial part of the proximal portion defining a coupling portion of the core of the intermediate waveguide 130.i. The molecules of the liquid crystal are consequently mostly oriented parallel to the Z-axis in the coupling portion, which is the polarization direction of the guided mode.

The thickness of the upper encapsulation layer 120 is thin enough for an evanescent part of the guided mode to interact with the coupling portion. Due to the orientation of the molecules parallel to the polarization direction of the guided mode, the refractive index of the coupling portion makes it possible for a mode excited by the evanescent part to propagate in the intermediate waveguide 130.i, that is to say that the propagation constants of the excited mode and of the guided mode are substantially equal in the coupling portion. Thus, part of the guided mode is optically coupled to the intermediate waveguide 130.i by evanescent coupling and exits through the output face 132.i to generate a transmitted light wave.

The transmitted light wave propagates in free space in the high-index region 260.i along a main axis until reaching the reflective surface 133.i. In the case where the reflective surface 133.i is a diopter, the main axis makes an angle α with a normal to the flat reflective surface 133.i greater than or equal to a minimum angle of incidence on the flat reflective surface 133.i for which the light is totally reflected. It is not necessary to observe this constraint in the case where the reflective surface 133.i is metallized.

The ratio between the energy of the light wave transmitted in the intermediate guide to the energy of the guided mode in the main guide defines a coupling efficiency. The coupling efficiency depends on a plurality of factors such as, for example, the refractive indices of the waveguides, the spacing thereof, etc. It depends particularly on the length of the coupling portion L_{c,i}. The length L_{c,i} of the coupling portion is also the length measured along the X-axis of the proximal portion within which the propagation constants of the excited mode and of the guided mode are equal. The length L_{c,i} depends on the arrangement of the buried electrode 105 and the upper electrode 205.i in relation to the liquid crystal. In this example, the buried electrode 105 is opposite the liquid crystal over the entire length of the core of the intermediate waveguide 130.i, the upper electrode 205.i is opposite the liquid crystal only at the entire straight portion of the core of the intermediate waveguide 130.i. The length L_{c,i} is therefore here equal to the length of the straight portion measured along the X-axis.

The coupling efficiency increases initially when the length L_{c,i} increases from a zero length to reach a maximum of the coupling efficiency for a length L_{c}, called optimal coupling length. It may subsequently decrease when the length L_{c,i} increases further, to increase again, and so on. The optimal coupling length L_{c} increases with the thickness of the upper encapsulation layer 120. It can be determined by simulation. For certain applications, such as for example to test a photonic chip, a low coupling efficiency, for example less than or equal to 5%, may be desired. For other applications, such as micro-displays, a higher or even maximum coupling efficiency may be desired. The length L_{c,i} can then be adjusted accordingly.

Optionally, upstream of the coupling portion in relation to the direction of propagation of the guided mode, another evanescent part of the guided mode interacts with an adiabatic coupling portion of the core of the intermediate waveguide 130.i so as to excite a fundamental mode of the intermediate waveguide 130.i. The adiabatic coupling portion comprises the end 131.i. The end 131.i being inclined in relation to the plane (X, Y), the surface of a cross-section of the core gradually increases in the direction of the coupling portion such that the effective index of the fundamental mode in the intermediate waveguide 130.i reaches that of the guided mode. It may therefore propagate in the intermediate waveguide 130.i and promote the energy transfer from the evanescent coupling to this fundamental mode at the coupling portion. Thus, the light wave guided in the main guide does not undergo an index discontinuity perceived at the evanescent part thereof, which reduces the losses of the extraction structure 10.i. The part of the energy of the guided mode transferred to the fundamental mode at the adiabatic coupling portion contributes to increasing the coupling efficiency of the main waveguide 115 to the intermediate waveguide 130.i.

Conversely, when a zero potential difference is applied between the buried electrode 105 and the upper electrode 205.i, the electric field is substantially zero within the liquid crystal. The molecules of the liquid crystal are consequently mostly oriented parallel to a direction favored by one or more anchoring layers, parallel to the plane (X, Y), here parallel to the Y-axis. Due to this orientation of the molecules, the guided mode interacts with a refractive index medium equal to the ordinary refractive index (no) in the coupling portion and no mode of the intermediate waveguide 130.i is excited, or guided. Thus, the guided mode remains confined in the main waveguide 115.

The sizing of the elements of the extraction structure 10.i can be optimized using electromagnetic wave propagation simulation tools implementing algorithms such as FDTD (Finite Difference Time Domain), FDE (Finite Difference Eigenmode) or EME (Eigen Mode Expension). The behavior of the liquid crystal, and therefore the refractive index thereof, when applying a potential difference between the buried electrode 105 and the upper electrode 205.i, can be deduced from simulation results obtained by a finite element method, such as that proposed by the commercially available COMSOL® software.

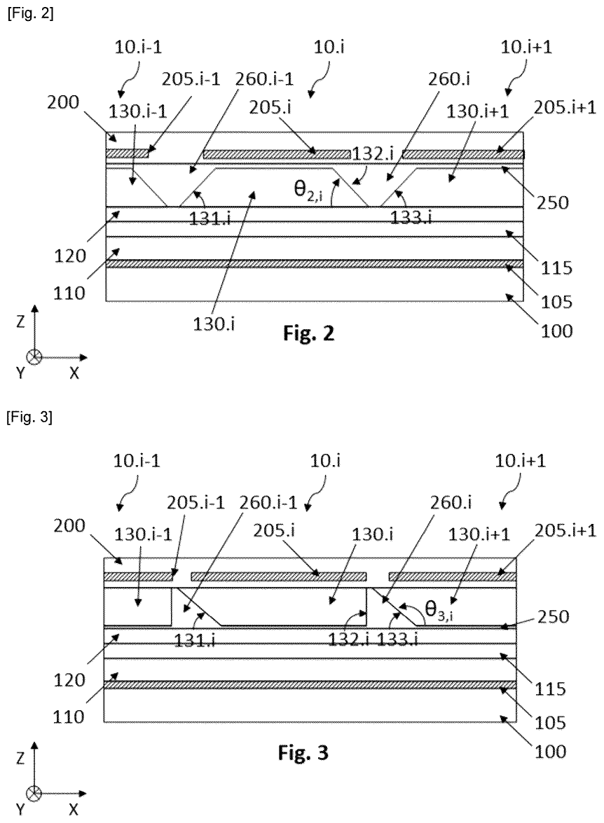

Now, a second embodiment will be described in connection with FIG. 2, for which the guided mode can propagate in two opposite directions of the main waveguide 115. Only the differences with the first embodiment are explicitly described.

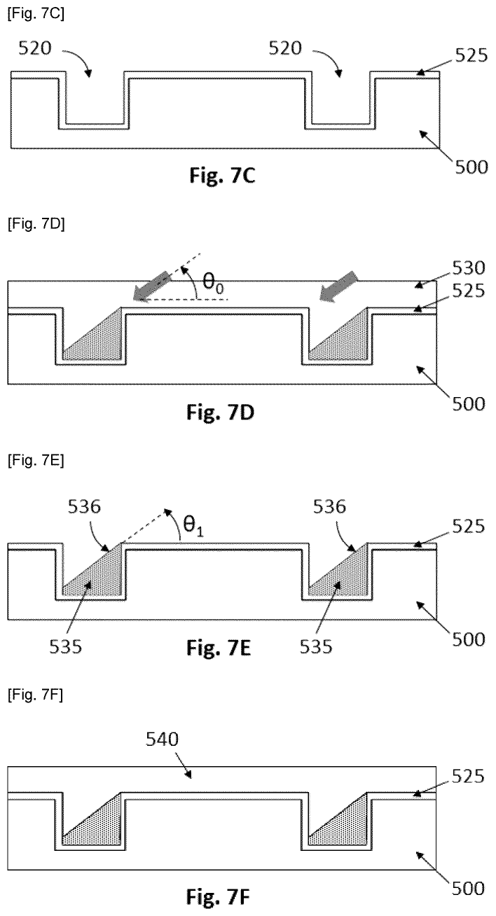

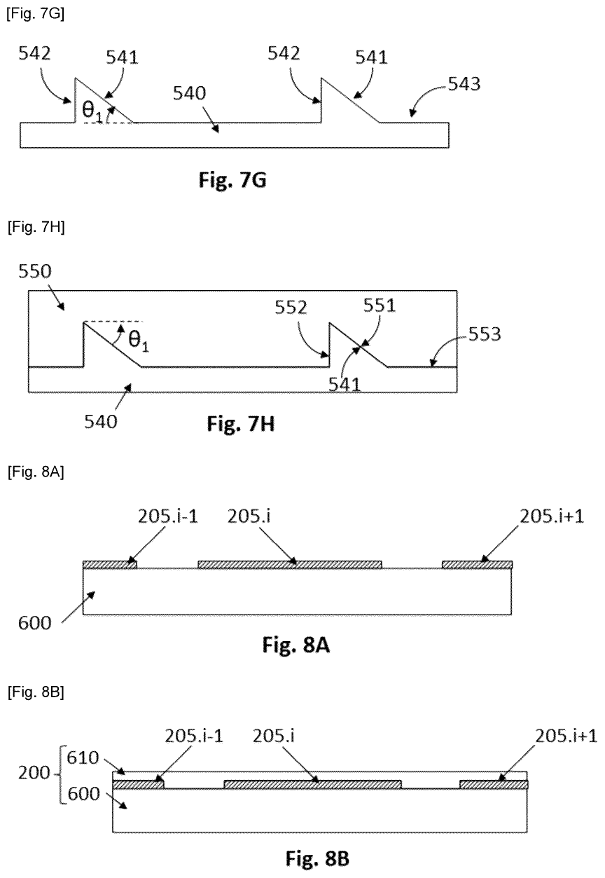

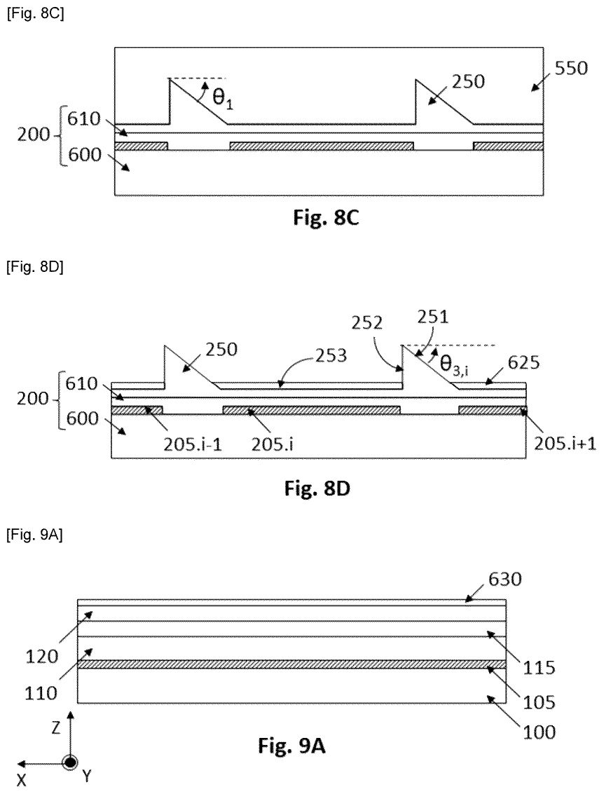

In this embodiment, θ_{2,i} is strictly less than 90° and strictly greater than 0°. This facilitates the manufacture of a reference mold 540 and a stamp mold 550 with the manufacturing method of FIGS. 7A to 7H, and facilitates the manufacture of an upper part of the extraction structure 10.i according to the manufacturing method of FIGS. 8A to 8D. The angle θ_{2,i} is for example substantially equal to the angle θ_{3,i}.

A third embodiment will be described in connection with FIG. 3. Only the differences with the first embodiment are explicitly described.

In this embodiment, the buried electrode 105 and the support substrate 100 are transparent at the wavelength λ. θ_{3,i} is strictly greater than 90°. Thus, the reflective surface 133.i orients the transmitted light wave in the direction of the support substrate 100, after reflection, to extract it through the lower face of the support substrate 100.

The first, second, and third embodiments have been described in connection with a TM polarization guided mode, extracted when a non-zero potential difference is applied between the first electrode 105 and the second electrode 205.i.

To extract a TM guided mode only when a zero potential difference is applied between the first electrode 105 and the second electrode 205.i, the first electrode 105 and the second electrode 205.i are for example arranged both, in a plane parallel to the plane (X, Y) in the encapsulation substrate 200, one facing an upstream region of the intermediate waveguide 130.i and the other facing a downstream region of the intermediate waveguide 130.i, closer to the output face 132.i than the upstream region. The direction favored by the anchoring layer(s) may be parallel to the Z-axis. This configuration is commonly described as in plane switching (IPS).

To extract a TE guided mode only when a zero potential difference is applied between the first electrode 105 and the second electrode 205.i, the first electrode 105 and the upper electrode 205.i may for example be arranged in the same manner as in FIGS. 1-3, and the direction favored by the anchoring layer(s) may be parallel to the Y-axis.

To extract a TE guided mode only when a non-zero potential difference is applied between the first electrode 105 and the second electrode 205.i, the first electrode 105 and the second electrode 205.i are for example both arranged in a plane parallel to the plane (X, Y) in the encapsulation substrate 200, on either side of a plane orthogonal to the plane (X, Y) comprising an optical axis of the main waveguide 115. The direction favored by the anchoring layer(s) may be parallel to the axis X.

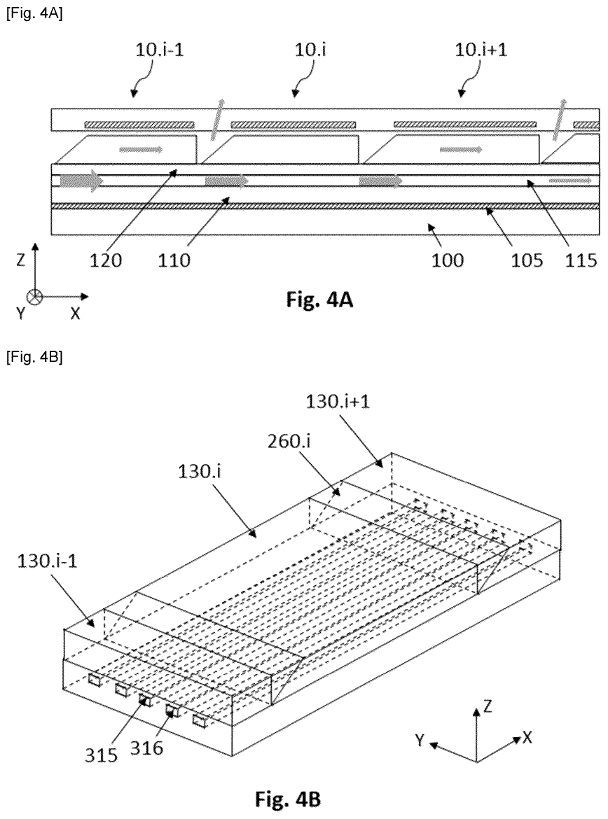

An optical device implementing extraction structures 10.i according to the first embodiment will now be described, in connection with FIGS. 4A and 4B. Alternatively, this optical device may implement extraction structures 10.i according to the second embodiment and/or according to the third embodiment, possibly in combination with one or more extraction structures 10.i according to the first embodiment. The orientations of the diopters represented in these figures constitute only a special case; other orientations may be considered based on the teaching of the first, second and third embodiments.

FIG. 4A is a cross-sectional view of the perspective view of FIG. 4B, passing through an optical axis of a first main waveguide 315. An example of propagation of a light beam is schematically represented in FIG. 4A in the form of gray arrows. The widths of the arrows schematically illustrate the relative energies of the light beam in the various branches of the optical device for a particular operation of the optical device.

The optical device comprises a first main waveguide 315 and at least one second main waveguide 316. The second main waveguide 316 here extends parallel to the main waveguide 315 in a plane coplanar with the main waveguide 315. In this example, without being essential, the first and second main waveguides 315, 316 are straight.

The optical device includes a first group of a plurality of extraction structures 10.i according to the first embodiment, sharing the support substrate 100, such that the main waveguide 115 of each extraction structure is a portion of the first main waveguide 315. An extraction structure 10.i here is interposed between two additional extraction structures 10.i−1, 10.i+1 according to the same embodiment as that of the extraction structure 10.i, here of the first embodiment. The end 131.i+1 of the additional extraction structure 10.i+1 is the reflective surface 133.i of the extraction structure 10.i. Similarly, the end 131.i of the extraction structure 10.i is the reflective surface 133.i−1 of the additional extraction structure 10.i−1.

Alternatively, the reflective surface 133.i−1 of an extraction structure 10.i−1 may be an interface, possibly metallized, between the high-index region 260.i−1 and any second medium, for example an adhesive. The adhesive may be a UV adhesive. The second medium may extend over the upper encapsulation layer 120 and have a thickness measured parallel to the Z-axis substantially equal to the height H_{g,i-1} of the intermediate waveguide 130.i−1 of the extraction structure 10.i−1.

In this example, the additional extraction structure 10.i−1 is intended to be activated and deactivated simultaneously with another extraction structure, here the additional extraction structure 10.i+1. The length L_{c,i-1} of the coupling portion of the additional extraction structure 10.i−1 here is strictly less than the length L_{c,i+1} of the coupling portion of the additional extraction structure 10.i+1. Preferably, a difference between the lengths L_{c,i-1} and L_{c,i+1} is such that the light waves transmitted by the additional extraction structures 10.i−1, 10.i+1 have equal intensities. The difference in lengths to achieve this goal can be established by photometric measurements of test structures or by simulation. In this preferred case, the additional extraction structures 10.i−1, 10.i+1 may, for example, be emission point extraction structures of a micro-display belonging to a set of emission points corresponding to a pixel of an image.

In the case where a plurality of extraction structures 10.i of the first group are intended to be activated simultaneously, the length L_{c,i} of the coupling portion of the extraction structure 10.i located most downstream in relation to the progression of the guided mode is preferably equal to the optimal coupling length L_{c}, particularly for a micro-display type application.

Here, the optical device further includes a second group of a plurality of extraction structures 10.i according to the first embodiment, sharing the support substrate 100, such that the main waveguide 115 of each extraction structure is a portion of the second main waveguide 316. As for the first group of extraction structures, an extraction structure 10.i of the second group is interposed between two additional extraction structures 10.i−1, 10.i+1 of the second group. More specifically, the end 131.i+1 of the additional extraction structure 10.i+1 is, in this example, the reflective surface 133.i of the extraction structure 10.i. Similarly, the end 131.i of the extraction structure 10.i is the reflective surface 133.i−1 of the additional extraction structure 10.i−1. The optical device may include any number of groups, each including a plurality of extraction structures 10.i.

In this example, the intermediate waveguide 130.i of each extraction structure 10.i of the first group and of the second group is a planar waveguide. More precisely, the intermediate waveguide 130.i of each extraction structure 10.i of the first group constitutes, together with the intermediate waveguide 130.i of a corresponding extraction structure 10.i of the second group, two parts of a common and planar intermediate waveguide 130.i. The common intermediate waveguide 130.i is opposite the first main waveguide 315 and the second main waveguide 316. Here, the end 131.i of each extraction structure 10.i of the first group is coplanar with the end 131.i of the corresponding extraction structure 10.i of the second group. Similarly, the output face 132.i of each extraction structure 10.i of the first group is coplanar with the output face 132.i of the corresponding extraction structure 10.i of the second group. It should be noted that it is possible to activate independently of one another, two extraction structures 10.i sharing a common intermediate waveguide 130.i, the respective coupling portions being defined by the geometry of the upper electrodes 205.i. That is to say that a difference in electrical potential applied between an upper electrode 205.i and the buried electrode 105 can orient the molecules of the liquid crystal in a corresponding coupling portion, without affecting the orientation of the molecules in the other coupling portions of the common intermediate waveguide 130.i. Any number of extraction structures 10.i belonging to distinct groups of extraction structures 10.i may have the respective intermediate waveguides 130.i thereof included in the common intermediate waveguide 130.i. In this example, 5 extraction structures 10.i belonging to distinct groups share a common planar intermediate waveguide 130.i.

The buried electrodes 105 of the extraction structures of the first group and/or of the second group can each be a portion of a common buried electrode extending continuously in a plane parallel to the plane (X, Y). The common electrode can be electrically connected to a fixed electrical potential, for example to the ground.

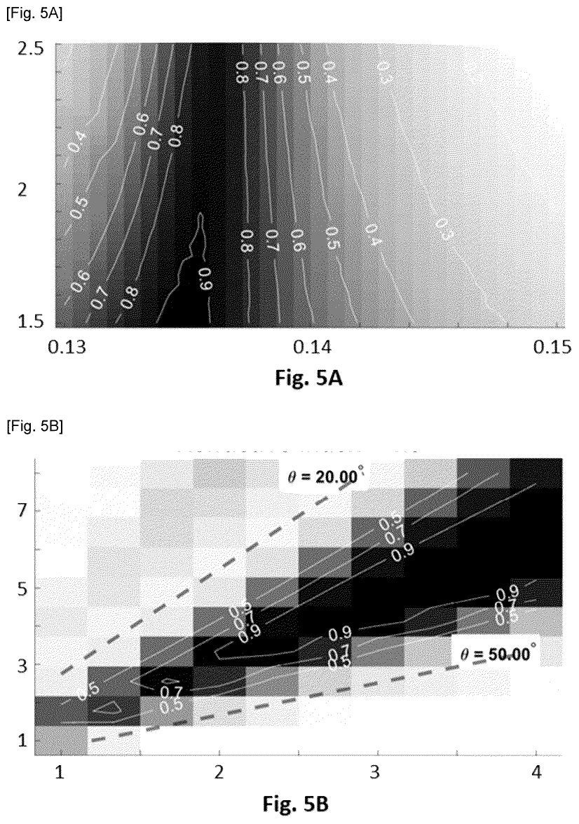

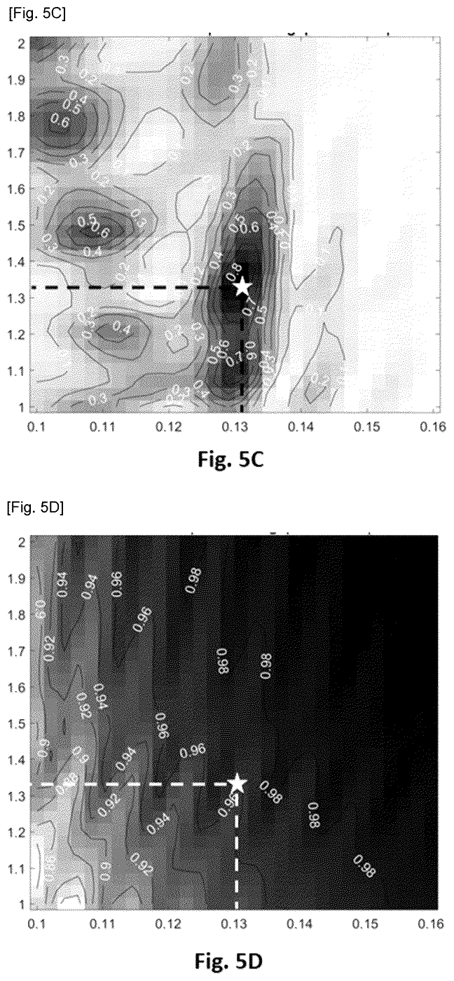

In connection with FIGS. 5A to 5D, simulation results will be described. These results are useful for sizing an extraction structure 10.i according to the invention.

In FIG. 5A, a two-dimensional mapping is shown giving the ratio of the energy of the light wave transmitted in the intermediate waveguide to the initial energy of the main guided mode (white iso-value lines), as a function of the height of the main waveguide 115 measured along the Z-axis (axis of abscissas, in μm) and of the height H_{g,i} of the intermediate waveguide 130.i (axis of ordinates, in μm). For these simulation results, the upper encapsulation layer 120 is made of silicon oxide and has a thickness equal to 100 nm. The wavelength λ is equal to 532 nm. The length L_{c,i} of the coupling portion is at each point equal to the optimal coupling length L_{c}. The liquid crystal is 5CB. The main waveguide 115 is made of silicon nitride (SiN). The guided mode is a transverse magnetic (TM) polarized mode. These results show that it is possible to adjust the maximum coupling efficiency over a wide range of values. The maximum coupling efficiency may be greater than 0.9.

In FIG. 5B, a two-dimensional mapping is shown giving the ratio of the energy of the transmitted light wave after reflection by the reflective surface 133.i to the energy of the transmitted light wave in the intermediate guide (white iso-value lines), as a function of the height H_{p,i} (axis of abscissas, in μm) and of the length L_{p,i} (axis of ordinates, in μm) of the reflective surface 133.i. For these simulation results, φ_{3,i} is equal to 0° and θ_{3,i} is variable and equal to

$${tan}^{- 1} \frac{{H}_{p , i}}{{L}_{p , i}} ,$$

as specified above. Two dotted lines locate the angles θ_{3,i} equal respectively to 20° and 50°. The high-index region 260.i comprises titanium oxide (TiO2) and has a refractive index equal to 1.9. The liquid crystal is 5CB. The height H_{g,i} of the intermediate waveguide 130.i is equal to the height H_{p,i} of the reflective surface 133.i. The reflective surface 133.i is a diopter separating the high-index region 260.i from a second refractive index medium equal to the ordinary refractive index (no) of the liquid crystal. The guided mode is a transverse magnetic (TM) polarized mode. The wavelength λ is equal to 532 nm. These results show that it is possible to determine a value of θ_{3,i} maximizing the reflective power of the reflective surface 133.i.

FIG. 5C is the result of the combination of FIGS. 5A and 5B for a length L_{p,i} of the reflective surface 133.i fixed at 2 μm. A two-dimensional mapping is shown here giving the ratio of the energy of the light wave transmitted after reflection by the reflective surface 133.i to the energy of the guided mode (black iso-value lines), as a function of the height of the main waveguide 115 (axis of abscissas, in μm) and of the height H_{p,i} (axis of ordinates, in μm) of the reflective surface 133.i. The height H_{p,i} being equal to the height of the intermediate waveguide 130.i. The other parameters for obtaining these simulation results take the same values as those mentioned in connection with FIG. 5A and FIG. 5B. A maximum equal to 90% (white star) is achieved for a height of the main waveguide 115 equal to 130 nm, a height of the intermediate waveguide 130.i equal to 1.32 μm, a thickness of the upper encapsulation layer 120 equal to 100 nm and an inclination of the reflective surface 133.i equal to

$${θ}_{3 \cdot i} = {tan}^{- 1} \frac{1.32}{2} = 33 ° .$$

The TM polarization of the guided mode is advantageous when the transmitted light wave is extracted through the upper face of the encapsulation substrate 200 or through the lower face of the support substrate 100 to a surrounding medium of low refractive index, such as for example a gas or air. In this case, the reflection of the light wave at the interface between the surrounding medium and respectively the encapsulation substrate 200 or the support substrate 100 is reduced, for example 5 times less, or even 6 times less than the reflection obtained with a TE type guided mode.

In FIG. 5D, a two-dimensional mapping is shown giving the ratio of the energy of the guided mode downstream of the extraction structure 10.i to the energy of the guided mode upstream of the extraction structure 10.i (black iso-value lines), as a function of the height of the main waveguide 115 (axis of abscissas, in μm) and of the height H_{p,i} (axis of ordinates, in μm) of the reflective surface 133.i. The simulation results are obtained when the buried electrode 105 and the upper electrode 205.i are at the same electrical potential. The operating point marked in FIG. 5C is shown in FIG. 5D, for which 96% of the energy of the guided mode remains confined in the main waveguide 115 when passing through the extraction structure 10.i.

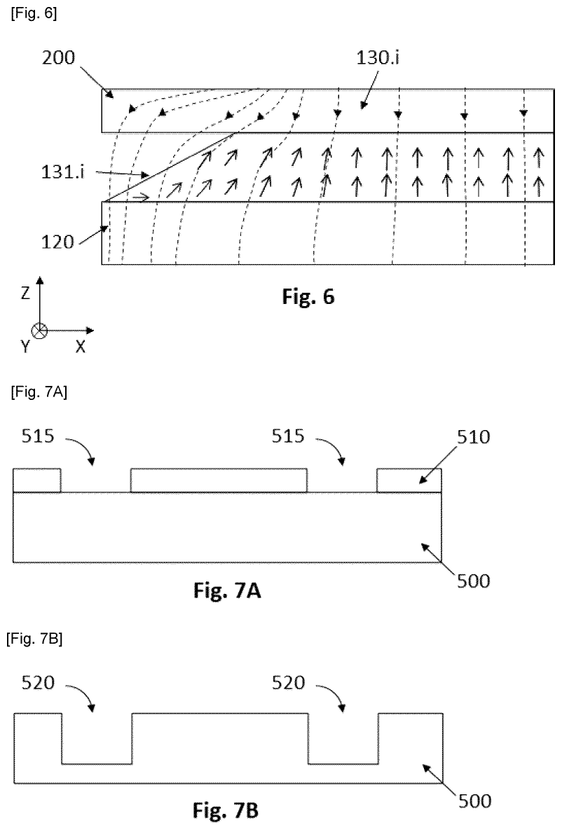

In FIG. 6, a mapping obtained by simulation of the electric field (orientated dotted lines) within a region of the first embodiment including the end 131.i of the intermediate waveguide 130.i is shown. For these simulation results, the direction favored by the anchoring layer(s) is parallel to the X-axis. The distance d_{es,i} is equal to 1 μm. The thickness of the lower encapsulation layer 110 is equal to 1 μm. An electrical potential difference equal to 5 V is applied between the upper electrode 205.i and the buried electrode 105. The upper electrode 205.i here is not facing the end 131.i. Consequently, a rectangular triangular section region in a plane parallel to the plane (X, Z), delimited by the end 131.i and a lower face of the intermediate waveguide 130.i, has an intermediate refractive index, variable in a range of values included between the ordinary refractive index (no) and the extraordinary refractive index (ne). The refractive index increases gradually as it moves away from the end 131.i, which favors the formation of an adiabatic coupling region. This also makes it possible to limit a diffraction effect of the guided mode at the interface between the high-index region 260.i and the liquid crystal, at the end 131.i.

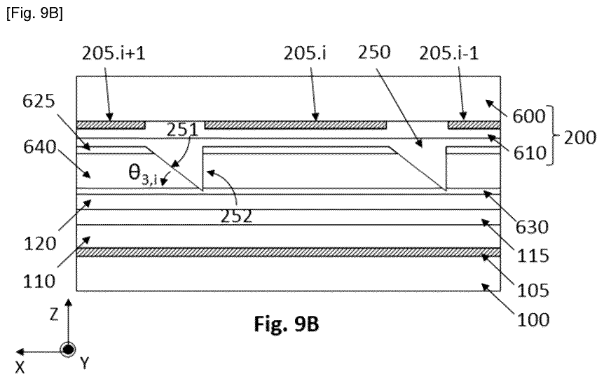

An example of method for producing an extraction structure 10.i as illustrated in FIG. 1A or FIG. 2 is now described. This method comprises manufacturing a reference mold 540 and a stamp mold 550 (FIGS. 7A to 7H), manufacturing an upper part of the extraction structure 10.i (FIGS. 8A to 8D) and the actual manufacturing of the extraction structure 10.i integrating the upper part (FIGS. 9A to 9C).

In FIG. 7A, a photosensitive resin is deposited on a temporary substrate 500. The photosensitive resin is locally insolated and developed to obtain a mask 510 in contact with the temporary substrate 500. Alternatively, the mask 510 may be a mineral structured layer, for example made of silicon nitride (SiN) or of silicon oxide, obtained by photolithography and etching steps. The mask 510 includes openings 515 passing through the mask 510 from one end to the other to expose regions of an upper face of the temporary substrate 500. The temporary substrate 500 may be a silicon substrate, for example a silicon plate, for example with a diameter of 150 mm, 200 mm or 300 mm. The openings 515 have for example rectangular shapes in a plane parallel to the upper face of the temporary substrate 500. In this particular example, the openings 515 are rectangular and extend in the direction of the lengths thereof in a common direction.

In FIG. 7B, the temporary substrate 500 is partially etched through the openings 515 to obtain trenches 520. The etching is an anisotropic etching, for example a reactive ion etching. The trenches 520 each have a bottom and walls substantially orthogonal to the bottom. They have substantially the same depth, for example greater than or equal to 10 μm, for example between 20 μm and 25 μm.

In FIG. 7C, an absorbent layer 525 is deposited in a conformal manner, for example by PVD or CVD, on the upper face of the temporary substrate 500, as well as on the bottoms and walls of the trenches 520. The absorbent layer 525 is optional. When it is present, the absorbent layer 525 may comprise an alternation of sub-layers made of chromium (Cr) and of silicon oxide.

In FIG. 7D, a positive photosensitive resin 530 is deposited on the absorbent layer 525, or directly on the temporary substrate 500 when the absorbent layer 525 is absent. The positive photosensitive resin 530 completely fills the trenches 520, advantageously it covers the upper face of the temporary substrate 500. The positive photosensitive resin 530 is subsequently insolated by a collimated light propagating in the positive photosensitive resin 530 along a direction making an angle θ₀ strictly between 0° and 90° with the upper face of the temporary substrate 500, this in order to insolate only a part of the positive photosensitive resin 530 inside the trenches 520. The angle θ₀ is preferably between 30 degrees and 60 degrees, or 30 degrees and 50 degrees. In this example the direction of the collimated light is orthogonal to the common direction.

In FIG. 7E, the positive photosensitive resin 530 is developed. At the end of this step, residual parts 535, not insolated, of the positive photosensitive resin 530 remain inside the trenches 520. Each residual part 535 covers the bottom, preferably entirely, with a respective trench 520. Each residual part 535 includes an inclined face 536 making a non-zero angle θ₁ with the upper face of the temporary substrate 500, substantially equal to θ₀. The inclined face 536 is flush with the upper face of the temporary substrate 500, and covers the bottom of the corresponding trench 520. The presence of an absorbent layer 525 during the insolation of the positive photosensitive resin 530 prevents the formation of interference fringes induced by a reflection on the walls of the trenches 520. The inclined faces 536 are then smoother.

In FIG. 7F, a non-conformal layer is formed on the temporary substrate 500 to produce a reference mold 540. The layer may be a metal layer, for example made of nickel (Ni). It can be deposited by CVD or PVD. It can also be obtained by an electroplating growth process, possibly preceded by the conformal deposition of an electricity-conducting germ. In the case where the absorbent layer 525 is present and comprises an alternation of sub-layers made of chromium (Cr) and silicon oxide, the layer may advantageously be grown by electroplating from a chromium (Cr) sub-layer terminating the alternation of sub-layers of the absorbent layer 525.

In FIG. 7G, the reference mold 540 is removed. The reference mold 540 includes protruding parts, in relief in relation to a main face 543 of the reference mold 540. Each protruding part comprises an inclined face 541 and a straight face 542. The inclined faces 541 each correspond to an inclined face 536 of a residual part 535. The straight faces 542 each correspond to a wall of a trench 520. In this example, the protruding parts constitute right prisms with a rectangular triangular section. Thus, each inclined face 541 defines an edge with a straight face 542. Here, all the edges of the protruding parts are parallel to each other and extend in a same plane parallel to the main face 543.

In FIG. 7H, a flexible layer, for example made of an elastomer such as polydimethylsiloxane (PDMS), is formed on the reference mold 540 so as to be in contact with the protruding parts and the main face 543 of the reference mold 540. The flexible layer constitutes a stamp mold 550 comprising cavities, each of shape corresponding to a protruding part of the reference mold 540. Thus, each cavity comprises an inclined face 551 and a straight face 552 corresponding respectively to an inclined face 541 and a straight face 542 of a protruding part of the reference mold 540. The step of FIG. 7H can be repeated a plurality of times to make a plurality of stamp molds 550. In this example, the cavities constitute right-angle prisms with a right triangular section. Each inclined face 551 defines an edge with a straight face 552. All the edges of the cavities are parallel to each other and extend in a same plane parallel to a main face 553 of the stamp mold 550 corresponding to the main face 543 of the reference mold 540. Each inclined face 551 makes an angle θ₁ with the main face 553.

In FIG. 8A, an electrically conductive layer is deposited on an upper face of a support 600. The support 600 is, in this example, made of a material transparent at the wavelength λ. It is for example made of silicon (Si) or germanium (Ge), if the wavelength λ is in the infrared. For example, it may be quartz or glass, if the wavelength λ is in the visible spectrum.

The electrically conductive layer may be a metal, or a metal oxide, such as for example an indium-tin oxide (ITO). It is etched locally over the entire thickness thereof to produce upper electrodes 205.i.

In FIG. 8B, an encapsulation layer 610 is formed on the support 600, so as to be in contact with the upper electrodes 205.i and the upper face of the support 600. The encapsulation layer 610 has, on a side opposite the upper electrodes 205.i, a flat face substantially parallel to the upper face of the support 600. The encapsulation layer 610 is made of a material transparent at the wavelength λ. It is, for example, made of the same material as the support 600. Here it is made of silicon oxide. The support 600 and the encapsulation layer 610 together define the encapsulation substrate 200.

In FIG. 8C, a structured layer 250 is produced by a nanoimprint lithography (NIL) method. For example, it is possible to deposit an imperfectly crosslinked xerogel layer comprising titanium oxide (TiO₂), possibly added with organic stabilizing agents and/or plasticizers and/or polycondensation inhibitors. The xerogel layer is subsequently molded by the stamp mold 550, possibly by heating it slightly, to obtain the structured layer 250. During this step, the stamp mold 550 is brought into contact with the xerogel and a pressure exerted on the stamp mold 550, perpendicular to the upper face of the support 600 is applied, until possibly bringing the stamp mold 550 into contact with the encapsulation layer 610. When the stamp mold 550 is not brought into contact with the encapsulation layer 610, the pressure is uniform so as to keep the main face 553 of the stamp mold 550 substantially parallel with an upper face of the encapsulation layer 610 opposite the support 600.

Consequently, in all cases, the main face 553 of the stamp mold 550 is substantially parallel with the upper face of the encapsulation layer 610 during shaping of the xerogel.

In FIG. 8D, an upper part of an extraction structure 10.i is obtained. The stamp mold 550 is removed and the structured layer 250 is heated to an elevated temperature so as to solidify and stabilize it. A concentration of titanium oxide (TiO₂) in the xerogel makes it possible to adjust the refractive index of the structured layer 250, for example to a value equal to 1.9.

At the end of the heating sub-step, the structured layer 250 comprises protruding parts each corresponding to a cavity of the stamp mold 550. The protruding parts of the structured layer 250 therefore consequently have edges corresponding to the edges of the cavities. The main face 553 of the stamp mold 550 being parallel with the upper face of the encapsulation layer 610, the edges of the protruding parts of the structured layer 250 are coplanar and parallel to the upper face of the layer 610. The protruding parts of the structured layer 250 consequently have identical heights, equal to a common height.

In this example, the stamp mold 550 has not been brought into contact with the encapsulation layer 610, such that the protruding parts of the structured layer 250 are in relief in relation to a main face 253 of the structured layer 250. Each protruding part comprises an inclined face 251 intended to be an end 131.i and/or a reflective surface 133.i of an extraction structure 10.i. It also includes a straight face 252 intended to be an output face 132.i of an extraction structure 10.i. The inclined face 251 makes an angle θ_{3,i} with the main face 253 which may be different from θ₁. The angle θ_{3,i} increases when θ₁, and therefore θ₀, increases.

A polyimide layer is subsequently formed in contact with the main face 253, or in contact with the encapsulation layer 610 when the stamp mold 550 has been brought into contact with it during the nanoimprint lithography step. The polyimide layer is brushed in a direction intended to be a favored direction for the orientation of the molecules of the liquid crystal when no electric field is present in the liquid crystal. The polyimide layer is thus intended to be an upper anchoring layer 625 of the liquid crystal.

In FIG. 9A, a lower part of an extraction structure 10.i is manufactured. An electrically conductive layer is deposited on an upper face of a support substrate 100. The support substrate 100 may for example be made of silicon, for example a silicon plate. The electrically conductive layer may be a metal, or a metal oxide, such as for example an indium-tin oxide (ITO). It is etched locally over the entire thickness thereof to produce a buried electrode 105.

A lower encapsulation layer 110 is subsequently deposited on the support substrate 100, in contact with the support substrate 100 and the buried electrode 105. The lower encapsulation layer 110 is for example made of silicon oxide. It may be polished, for example by chemical mechanical polishing.

A dielectric or semiconductor layer is subsequently formed on the support substrate 100, by a layer transfer technique or by a deposition, possibly followed by a planarization step, for example by chemical mechanical polishing. The layer is subsequently etched locally over the entire height thereof to obtain the core of a main waveguide 115.

An upper encapsulation layer 120 is subsequently deposited on the lower encapsulation layer 110, in contact with the lower encapsulation layer 110 and the main waveguide 115. The upper encapsulation layer 120 is for example made of silicon oxide. It may be polished, for example by chemical mechanical polishing.

An additional polyimide layer is subsequently formed in contact with the upper encapsulation layer 120, on at least one part of the upper encapsulation layer 120. The additional polyimide layer is brushed in a direction intended for a favored direction for the orientation of the molecules of the liquid crystal when no electric field is present in the liquid crystal. The additional polyimide layer is thus intended to be a lower anchoring layer 630 of the liquid crystal.

In FIG. 9B, an adhesive bead (not shown) is formed on the lower anchoring layer 630 or in contact with the upper encapsulation layer 120. The adhesive bead is closed, that is to say that it defines a central area. It includes at least one through lateral opening communicating with the central region. The central region may for example have a substantially rectangular shape.

The upper part of FIG. 8D is transferred to the upper encapsulation layer 120, so as to bring the protruding parts of the structured layer 250 into contact with the lower anchoring layer 630 at the central region. Preferably, all protruding parts are entirely facing the central region. Sufficient pressure may be applied to the upper part to press the protruding parts into the lower anchoring layer 630, possibly until the protruding parts come into contact with the upper encapsulation layer 120. The adhesive bead fixes the upper part to the lower part. The structured layer 250 acts as a spacer fixing a gap between the support substrate 100 and the encapsulation substrate 200. A liquid crystal 640 is subsequently introduced into the central region through the through lateral opening so as to fill the entire volume delimited by the adhesive bead and the lower and upper anchoring layers 630, 625. The through lateral opening is subsequently closed.

At the end of this step, a continuous volume, delimited by the structured layer 250, the upper encapsulation layer 120 and, possibly, the encapsulation layer 610 when the stamp mold 550 has not been brought into contact with the encapsulation layer 610, defines a core of an intermediate waveguide 130.i. The core extends between two protruding parts of the structured layer 250. The inclined face 251 of a protruding part constitutes a reflective surface 133.i of the intermediate waveguide 130.i. The straight face 252 of the same protruding part constitutes an output face 132.i of the intermediate waveguide 130.i. If the structured layer 250 includes at least 3 protruding parts, a plurality of cores belonging to respective intermediate waveguides 130.i are defined in this way at the same time. They all have the same height measured orthogonally to the main plane of the support substrate 100, since the edges of the structured layer 250 are coplanar and parallel to the upper face of the layer 610.

Alternatively, the nanoimprint lithography step of FIG. 8C may be performed on the lower part of FIG. 9A. The adhesive bead is formed on the lower part after the nanoimprint lithography step. The step of FIG. 8C is omitted, and the upper part of FIG. 8B is transferred to the lower part and fixed by the adhesive bead. This embodiment is advantageous for producing the third embodiment of FIG. 3, particularly for aligning more precisely the protruding parts of the structured layer 250 in relation to the main waveguide 115.

Particular embodiments have just been described. Various alternative embodiments and modifications will become apparent to the person skilled in the art. For example, the simulation results were obtained with a wavelength in the visible domain, suitable for making a micro-display, but similar results can be obtained with a wavelength useful in the field of optical telecommunications, for example substantially equal to 1,550 nm.

1. A structure for extracting a guided mode of wavelength λ, linearly polarized along a polarization direction, comprising:
a support substrate 100 comprising a substantially flat upper face,
a main waveguide configured to guide the guided mode,
an intermediate waveguide configured to guide a so-called coupled mode, at the wavelength λ, comprising a liquid crystal core extending parallel to the upper face, and an output face, the core extending to the output face,
a flat surface facing the output face, reflective at the wavelength λ, making a non-zero angle with the upper face of the support substrate,
a first electrode and a second electrode, arranged with respect to the core of the intermediate waveguide so as to switch, in a coupling portion of the core of the intermediate waveguide, a refractive index of the liquid crystal, along the polarization direction, from a first level to a second level, when a variation of an electrical potential difference is applied between the first and the second electrodes,
wherein the first level, the second level, and the arrangement of the coupling portion with respect to the main waveguide is such that the guided mode, when it is present, is at least partially coupled, by evanescent coupling from the main waveguide to the coupling portion only when the refractive index of the coupling portion is equal to the second level.

2. The extraction structure according to claim 1, wherein the first electrode is a buried electrode, and wherein:
the buried electrode, the main waveguide, the intermediate waveguide and the second electrode extend in distinct planes, parallel to the upper face of the support substrate,
the main waveguide and the intermediate waveguide are interposed between the buried electrode and the second electrode.

3. The extraction structure according to claim 1, wherein the flat reflective surface is an interface between a first medium and a second medium transparent at the wavelength λ, wherein the first medium is arranged between the output face and the flat reflective surface and has a refractive index strictly greater than a refractive index of the second medium, and wherein the extraction structure is such that, when the guided mode is present and at least partially coupled, a transmitted light wave from the guided mode propagates from the output face to the reflective plane surface along a main axis making an angle α with a normal to the reflective plane surface greater than or equal to a minimum angle of incidence on the flat reflective surface for which the light is totally reflected.

4. The extraction structure according to claim 1, wherein the intermediate waveguide has an end opposite the main waveguide, the core extending from the end to the output face.

5. The extraction structure according to claim 4, wherein the end makes a non-zero angle with the upper face of the support substrate so as to achieve an adiabatic coupling region.

6. The extraction structure according to claim 1, wherein the flat reflective surface is a metallized surface.

7. The extraction structure according to claim 1, wherein, the guided mode is a TM mode, the liquid crystal includes a nematic phase and the second level is an extraordinary refractive index of the liquid crystal.

8. The extraction structure according to claim 1, wherein the wavelength λ is included in the visible spectrum.

9. An optical device comprising a first group of a plurality of extraction structures according to claim 4, sharing the support substrate, such that the main waveguide of each extraction structure is a portion of a first main waveguide.

10. The optical device according to claim 9, further comprising a second group of a plurality of extraction structures sharing the support substrate with each other and with the extraction structures of the first group, such that the main waveguide of each extraction structure of the second group is a portion of a second main waveguide distinct from the first main waveguide.

11. The optical device according to claim 10, wherein, to each extraction structure of the first group corresponds a corresponding extraction structure of the second group such that the intermediate waveguides thereof are two portions of a common intermediate waveguide.

12. The optical device according to claim 9, wherein the flat reflective surface of each extraction structure of the first group and, if applicable, of the second group is the end of the intermediate waveguide of another extraction structure of the same group.

13. The optical device according to claim 11, wherein the intermediate waveguide of each extraction structure has an end opposite the main waveguide, the core extending from the end to the output face, and wherein the end of each extraction structure makes a non-zero angle with the upper face of the support substrate so as to achieve an adiabatic coupling region.

14. The optical device according to claim 9, wherein all the intermediate waveguides of the extraction structures have equal heights, measured perpendicularly to the upper face.

15. A method for manufacturing an extraction structure according to claim 1, comprising the following steps:
providing a support substrate comprising a main waveguide,
providing an encapsulation substrate,
forming a structured layer on the support substrate or the encapsulation substrate, by a nanoimprint lithography method, the structured layer comprising protruding parts of identical heights equal to a common height,
forming an adhesive bead on the support substrate or the encapsulation substrate, such that the adhesive bead has a thickness greater than or equal to the common height, delimits a central region, and includes a through lateral opening communicating with the central region,
transferring the encapsulation substrate onto the support substrate so that the structured layer acts as a spacer fixing a gap between the encapsulation substrate and the support substrate, and delimits a continuous volume in the central region that is to be to be the core of the intermediate waveguide,
bonding the encapsulation substrate to the support substrate by the adhesive bead,
introducing a liquid crystal into the continuous volume through the through lateral opening.

16. The manufacturing method according to claim 15, wherein the nanoimprint lithography method implements a reference mold obtained by the following steps:
providing a temporary substrate comprising an upper face and trenches extending deep into the temporary substrate from the upper face,
filling the trenches with a positive photosensitive resin,
insolating the positive photosensitive resin by a collimated light propagating in the positive photosensitive resin in a direction making an angle θ0 between 30° and 60° with the upper face.
